(19) United States
(12) Patent Application Publication
(10) Pub. No.: US 2024/0165605 A1
(43) Pub. Date: May 23, 2024

(54) Fluid Flow System and Fluid Control System

(71) Applicant: Northstar Medical Technologies, LLC, Beloit, WI (US)

(72) Inventors: Erik BLUEMNER, Verona, WI (US); Dorian LUST, Columbus, WI (US); Kaela RYAN, Monona, WI (US)

(73) Assignee: Northstar Medical Technologies, LLC, Beloit, WI (US)

(21) Appl. No.: 18/512,611

(22) Filed: Nov. 17, 2023

Related U.S. Application Data
(60) Provisional application No. 63/426,565, filed on Nov. 18, 2022.

(51) Int. Cl. B01L 3/00; B01D 15/42

(52) U.S. Cl. CPC B01L 3/502; B01D 15/424; B01L 2200/026; B01L 2300/0663; B01L 2300/088; B01L 2400/0644

(57) ABSTRACT

A fluid flow system configuration which simplifies the automation of fluid control, particularly for chemical processing systems where the minimization of fluid usage and processing speed are desired, particularly for the elution of radiopharmaceutical products. The fluid flow system comprises one or more input fluid containers for inputting fluid into the fluid flow system; a fluid flow control system coupled to the fluid flow containers, wherein the fluid flow control system controls and regulates fluid flowing through the fluid flow system; and one or more output fluid containers for receiving fluid outputted from the fluid flow control system. The fluid flow system integrates the use of single or multiple control reversing bypass valves as part of a fluid flow control system, whereby each reversing bypass valve can independently control flow direction forward, reverse, and/or bypass through the same flow path loop.

### CROSS-REFERENCE TO RELATED APPLICATION

This application claims the benefit of the filing date of U.S. provisional application Ser. No. 63/426,565, filed Nov. 18, 2022, entitled, “A Fluid Flow System and Fluid Control System,” all of which is hereby incorporated by reference as if fully set forth herein.

### FIELD OF THE INVENTION

This disclosure generally relates to a fluid flow system with a fluid control system. A particular application is directed to fluid control systems for chemical elution. A further particular application for such fluid control systems is for elution for radiopharmaceutical products, particularly for nuclear medicine and, more particularly, to methods of processing radioactive nuclides.

### BACKGROUND

Fluid flow systems typically consist of fluid pathways, pumps for fluid movement, fluid reservoirs, and containers, sensors for fluid properties such as pressure, flow rate, pH, temperature, transmissivity, conductivity, etc., and components for mechanical actuation. Fluid flow systems can be used for mixing, chemical reactions, and dosing of fluids. Fluid control systems typically work by moving fluids from reservoirs to the various sensors, fluid actuation components, and mixing systems in a prescribed sequence or in some manner of prescribed control.

One such fluid flow system is one used for chemical elution. Chemical elution is a process for extracting one material from another by washing with a solvent. Prior to this process, two substances are bound to each other. These two substances are typically placed in a separation column, such as a liquid chromatography column. Elution is performed in the separation column to remove one substance, an analyte or eluate, from an adsorbent. During the process, a liquid solvent or eluent is run through the separation column. As the solvent travels down the separation column, the solvent displaces the analyte from the adsorbent by replacing the analyte, and the analyte flows out of the separation column.

Such a chemical elution process has many applications, including general chemical processing, pharmaceutical processing, food and beverage processing, and environmental analysis. Chemical elution is a form of purification and allows for separating components in a mixture.

One particular application of chemical elution is for the production of radioactive materials in nuclear medicine for therapeutic and diagnostic purposes.

In the case of diagnostic medicine, radioactive material can be used to track blood flow for purposes of detecting obstructions or the like. In such a case, the radioactive material (e.g., a tracer) can be injected into a vein of the arm or leg of a person. A scintillation camera can be used to collect images of the person following the injection. In such a case, the gamma rays of the tracer can interact with a detector of the camera to create images of the person. A series of images can be collected as the tracer perfuses through the person. Since the tracer diffuses through the blood of the person, the veins or arteries with greater blood flow produce a greater signature from the tracer.

Alternatively, radioactive material can be coupled at a molecular level with a biolocalization agent. In such a case, the biolocalization agent can concentrate the radioactive material at some specific location (e.g., the site of a tumor).

A key to the use of radioactive materials in nuclear medicine is the creation of nuclear materials with a relatively short half-life (e.g., 2-72 hours). In the case of using radioactive materials with a biolocalization agent or for imaging, the short half-life causes the radioactivity to decay rapidly in such a way as to reduce the exposure of the person to the radiation.

While using radioactive materials in nuclear medicine is extremely useful, handling such materials can be difficult. Materials with short half-lives can require complex separation procedures to isolate the desired material from other materials. Once separated, the desired material must be easily accessible. An example of a method for handling and producing such materials is shown in U.S. Pat. No. 9,336,912 (Isensee). One process for producing such materials is through chemical elution using one or more separation columns.

Fluid flow systems, including those for chemical elution and production of radioactive materials, typically have specific through, reversing, and bypass functionality. Typically, a multitude of both valves and multiple flow paths have been necessary for such a fluid flow system. As a result, there are areas of dead space throughout the fluid flow process and system. One drawback to such systems is that significant volumes of fluid are required to rinse and clean the various flow paths and components, particularly for the areas of dead space. This functionality has also been performed using a multitude of switching/shuttle valves found in typical fluid control applications. However, several valves and multiple flow paths are required to accomplish this. This is especially true for the production of radiopharmaceuticals such as those described above. Accordingly, such typical fluid flow systems are costly, time-consuming, and wasteful.

A fluid flow system to simplify the automation of fluid control, particularly for chemical processing systems where the minimization of fluid usage and processing speed, is desired. One particular use envisioned is for the elution of radiopharmaceutical products. Such a system will be much more efficient and cost-effective, with a reduction in processing and cleaning time and fluids and materials used.

### BRIEF SUMMARY

The present invention is directed to a fluid flow system configuration which simplifies the automation of fluid control, particularly for chemical processing systems where the minimization of fluid usage and processing speed are desired. The particular use envisioned is for the elution of radiopharmaceutical products.

The present invention is directed to a fluid flow system comprising one or more input fluid containers for inputting fluid into the fluid flow system; a fluid flow control system coupled to the fluid flow containers, wherein the fluid flow control system controls and regulates fluid flowing through the fluid flow system; and one or more output fluid containers for receiving fluid outputted from the fluid flow control system. The present invention integrates the use of single or multiple control reversing bypass valves as part of a fluid flow control system, whereby each reversing bypass valve can independently control flow direction forward, reverse, and/or bypass through a connected flow path loop. The present invention has multiple configurations of the fluid path such that, between the input selection and the output selection, there is a single or simple flow path without any side paths and dead spaces. All possible fluid path surfaces are part of at least one configuration without dead space or side paths, which allows for low fluid volume cleaning of the entire fluid path, maintaining a flow path without any dead space. The elimination of dead space can be of critical importance to reducing rinse volumes and minimizing residual fluid between runs of different fluid through the flow path.

Some aspects of the present invention pertain to a fluid flow system including one or more input fluid containers for inputting fluid into the fluid flow system; a fluid flow control system coupled to the fluid flow containers, wherein the fluid flow control system controls and regulates fluid flowing through the fluid flow system; and one or more output fluid containers for receiving fluid outputted from the fluid flow control system.

Some aspects of the present invention pertain to the fluid flow control system including one or more reversing bypass valves.

Some aspects of the present invention pertain to the fluid flow control system including a first input selection; a fluid component; a reversing bypass valve; a flow path loop; and a fluid output selection.

Some aspects of the present invention pertain to the fluid flow system including input fluid components for moving fluid from the input fluid containers to the fluid flow control system, and output fluid components for moving from the fluid flow control system to the output fluid containers.

Some aspects of the present invention pertain to the fluid flow system being a chemical elution system.

Some aspects of the present invention pertain to the fluid flow system being a system designed for separating radionuclides.

Some aspects of the present invention pertain to an elution system, including a plurality of fluid containers; a plurality of fluid input components downstream and in fluid communication with the plurality of fluid containers; at least one fluid input selection downstream and in fluid communication with the plurality of fluid input components; a first fluid movement device downstream and in fluid communication with the at least one fluid input selection; a control valve system downstream of the fluid movement device, designed to control a flow path of a fluid flowing through the elution system; at least one separation column in fluid communication with the control valve system; at least one fluid output selection downstream of the control valve system and in fluid communication with the control valve system; a plurality of fluid output components downstream and in fluid communication with the at least one fluid output selection; and a plurality of fluid output containers downstream and in fluid communication with the plurality of fluid output components.

Some aspects of the present invention pertain to the control valve system being a reversing bypass valve.

Some aspects of the present invention pertain to the reversing bypass valve being a rotary reversing bypass valve.

Some aspects of the present invention pertain to the control valve system including a plurality of valves.

Some aspects of the present invention pertain to the elution system including a flow path loop in fluid communication with the control valve system and the first fluid movement device, and upstream of the at least one fluid output selection.

Some aspects of the present invention pertain to the flow path loop including a second fluid movement device.

Some aspects of the present invention pertain to the flow path loop including at least one of a flow sensor, a pressure sensor, a temperature sensor, fluid conductivity sensor, and a radiation detector.

Some aspects of the present invention pertain to a position of the control valve system being based on a value from the at least one of the flow sensor, the pressure sensor, the temperature sensor, fluid conductivity sensor, and the radiation detector.

Some aspects of the present invention pertain to the elution system including at the least one separation column in the flow path loop.

Some aspects of the present invention pertain to when the control valve system is in a first position, the fluid flows from the at least one fluid input selection to the at least one fluid output selection, without traveling through the flow path loop.

Some aspects of the present invention pertain to when the control valve system is in a second position, the fluid flows from the at least one fluid input selection, through the flow path loop, and to the at least one fluid output selection.

Some aspects of the present invention pertain to when the control valve system is in a third position, the fluid flow from the at least one fluid output selection, through the flow path loop, and to the at least one fluid input selection.

Some aspects of the present invention pertain to wherein the at least one separation column is designed to separate radionuclides.

Some aspects of the present invention pertain to wherein the at least one separation column is designed for a chemical elution process.

### BRIEF DESCRIPTION OF THE DRAWINGS

In the drawings forming a part of this disclosure,

FIG. 1 is a block diagram of an exemplary embodiment of a fluid flow system with a fluid flow control system.

### DETAILED DESCRIPTION

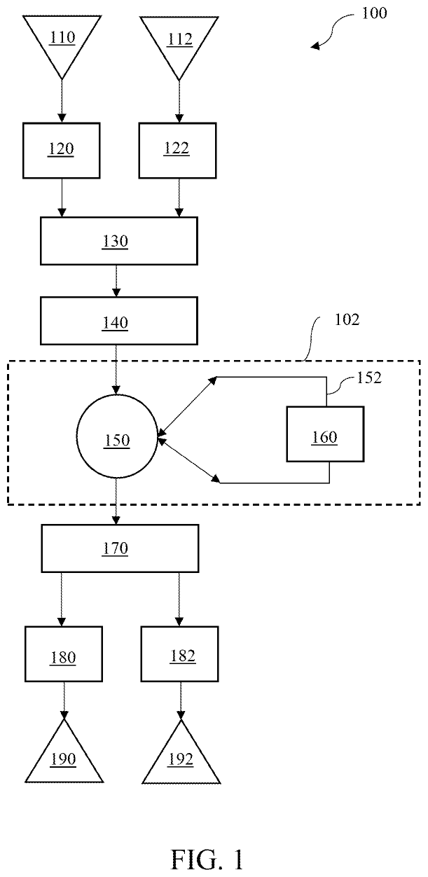

FIG. 1 is a block diagram of an exemplary embodiment of a fluid flow system 100 with a fluid control system 102

In one exemplary embodiment, the fluid flow system is directed to an elution system that can be used to separate radionuclides, such as those mentioned above, which can provide highly pure radioactive materials for use in diagnostic or therapeutic processes. The system can be constructed as a stationary or a portable device that is simple to use in radionuclide production facilities, nuclear pharmacies, or other medical environments with various embodiments depending upon the isotope.

The fluid flow system 100 can include one or more input fluid containers. In one embodiment, the input fluid containers can be comprised of multiple fluid containers. In the embodiment of FIG. 1, two input fluid containers 110, 112 are illustrated. Each input fluid container 110, 112 can also include multiple fluid containers. The invention is not limited in the number of input fluid containers. In an exemplary embodiment, one or more of the input fluid containers 110 can include a liquid such as a liquid solvent or eluent for elution, while one or more fluid containers 112 can include source material such as, for example, a solution of K₂MoO₄, KOH, KNO₃. Still, other input fluid containers can include a liquid such as saline, water, NaOH, or a similar fluid. Further, each input fluid container 110, 112 and/or the multiple fluid containers included in each of the fluid input containers 110, 112 can contain a different fluid, such as different sources and/or rinsing fluids.

The input fluid containers 110, 112 can be connected to fluid input components 120, 122, respectively. In one embodiment, the fluid input components are fluid path lines, piping, or streamlines. These fluid path lines can include pumps and/or switches for transporting the liquid and materials in the input fluid containers 110, 112 to flow out of the containers and be input into a fluid flow control system. Thus, in instances where the fluid containers contain multiple fluids, the system 100 can be designed to select between the multiple fluids. This can be beneficial because the system 100 can be utilized to run multiple sources or rinsing fluids across a separation column included in the system 100.

The fluid input components 120, 122 can be connected to a fluid input selection 130. In an exemplary embodiment, the fluid input selection 130 can be a manifold, chamber, or inlet valve for the intake of the fluids from the various input fluid containers. In a further exemplary embodiment, a standard rotary valve can be used as the fluid input selection 130. In another embodiment, the fluid input selection 130 is a standard 3/2 valve to select between different inputs, such as those from the input fluid containers 110, 112 and the fluid input components 120, 122.

The fluid input selection 130 can be connected to a fluid component 140. The fluid component 140 can include a fluid movement device designed to control the flow and/or flow rate of a fluid traveling through the system 100. In an exemplary embodiment, the fluid component is a flow-through component, such as a pump, a pump manifold, or a chamber to move the fluid, and is part of a fluid flow control system.

The fluid flow control system 102 can include a control valve system 150. In an exemplary embodiment, the control valve system 150 is a reversing bypass valve(s). In a further exemplary embodiment, the reversing bypass valve is a rotary reversing bypass valve. In still a further embodiment, a sequence of fluid flow control systems 102 can be used. The one or more fluid control systems 102 can allow for the use of one or more elution columns while still maintaining a fluid flow path without any dead spaces. The elimination of these dead spaces reduces rinse volumes and minimizes residual fluid between runs of different fluids through the flow paths.

In instances where the control valve system 150 includes reversing bypass valve(s), the reversing bypass valves can be coupled to a flow path loop 152. In one embodiment, a pump 160 is located in the flow path loop 152 to move fluid back and forth through the loop. As shown in FIG. 1, in some instances, the pump 160 can be downstream of a first fluid movement device (i.e., a fluid movement device included in the fluid component 140). In other instances, the pump 160 can be upstream of a first fluid movement device included in the system 100.

Further, the reversing bypass valve(s) can be configured to run forward through the pump 160 on the flow path loop connected to it. This can be called a Forward Through Loop. When the reversing bypass valve(s) are in this position, it allows fluid to flow from the input through the loop and out the output (or in the reverse direction by reversing input and output). This position is unique in that the entire flow path is utilized between the input and the output, and there are no dead-spaces. It is advantageous because it reduces the required rinsing/cleaning fluid volumes.

The reversing bypass valve(s) can also be configured to run backward through the pump on the flow path. This can be called a Reverse Through Loop. When reversing bypass valve(s) are in this position, it allows fluid to flow from the input through the loop and out the output, but through the loop in a direction opposite that of the first position (the input and output can be reversed as well).

The reversing bypass valve can also be configured to bypass the flow path loop. When the reversing bypass valve(s) are in this position, it allows fluid to flow from the input to the output without traveling through the loop (the input and output can be reversed).

The flow path loop 152 can include one or more separation columns, chromatography columns, or other chemical separation or elution elements. In a further embodiment, the flow path loop 152 can include sensors and/or pumps. In one exemplary embodiment, a flow sensor could be located on the flow path loop 152 to measure, regulate and control fluid flow through the loop 152. In another exemplary embodiment, a radiation detector can be located on the flow path loop 152 to measure the radioactivity of the fluid in the loop. The operation can then be adjusted, turned off, or turned on based on the readings from the radiation detector. Pressure, temperature, conductivity, and other common sensors can also be located on the flow path loop 152. Fluid can then be run through the separation column(s), either forward or reverse, to perform chemical elution.

In some instances, the position of the one or more valves included in the control valve system 150 are controlled based on a predetermined sequence of fluid movements and/or a recipe for a particular elution process. Thus, the flow path loop 152 can include one or more sensors and/or pumps to control the fluid flow through the loop 152 according to the predetermined sequence and/or the recipe.

The separation column(s) can be selected for the purification of a wide range of radionuclides depending on the diagnostic or therapeutic objectives. For example, the separation column can be filled within a chromatographic material (e.g., ion-exchange resin, extraction chromatographic material, etc.) targeted for the specific radionuclide needed. In this regard, the system 100 can be used for the purification of yttrium-90, bismuth-212 and 213, or rhenium-188 for radiotherapy or technetium-99 m, thallium-201, fluorine-18 or indium-111 for diagnostic imaging. The reversing bypass valve 150 can be connected to a fluid output selection 170. In an exemplary embodiment, the fluid output selection 170 is a manifold or outlet valve. In another exemplary embodiment, the fluid output selection 170 is a typical type of fluid control valve. For example, the valve can be a rotary valve or a 3/2 type valve. Such valves would eliminate dead space. This keeps the fluid volumes used for cleaning/rinsing to an absolute minimum.

In one embodiment, one or more of the fluid input selection 130, the fluid component 140, the control valve system 150, the flow path loop 152, and the output selection 170 form a fluid flow control system 102.

The fluid output selection 170 can be connected to fluid output components 180, 182. In one embodiment, the fluid output components are fluid path lines, piping, or streamlines. Sensors such as, for example, pressure sensors, flow sensors, temperature sensors, and radioactivity sensors can be included in the fluid output components. Further, the fluid output components could include one or more pumps. These output fluid path lines and components can be connected to one or more fluid output containers 190, 192. These fluid output containers can collect the result of the fluid flow system, such as the result of the chemical separation or elution.

The fluid output selection 170 can also be connected to the fluid input containers 110, 112. Thereby, fluid that was not used in the chemical separation or elution can be returned to the input and run again through the fluid flow system.

In a further exemplary embodiment, in addition to the components discussed above, other components of the system can include one or more fluid power devices (pumps) and could include fluid sensors. Pumps can be used to flow liquids across chromatography columns in sequential order from the top diagrammatically down to the bottom or from bottom to top as desired. Different liquids can interact differently with the chromatography columns present.

Further, the flow rate and volume through the pumps can be controlled. The pump control can be achieved with no feedback by simply running the pump off of a calibration. In other instances, the pump can be included in a closed loop with a flow sensor, one or more pressure sensors, or a combination of flow and pressure sensors. Thus, the control of a pump in a fluid path configuration, as defined in FIG. 1, can allow a partial amount of a starting volume of fluid in an input container, such as the input containers 110,112, to be moved across a chromatography column at a controlled flow rate. Accordingly, the fluid flow system 100 can be utilized for various elution processes, such as fractional elution.

The use of the reversing bypass valve in the above elution system allows for unique control of a fluid path that can be completely connected for simplified, low-fluid volume cleaning. The configuration of these components is such that when the reversing bypass valve is positioned appropriately, for example, as shown in FIG. 1, there is a single path or a simple path, without areas of dead space, through which fluids can flow from fluid input to fluid output. The single or simple flow path includes all fluid flow surfaces between the input and output and is free of side-paths or dead spaces, thus requiring smaller volumes of fluid for chromatography and cleaning. The result is no dead spaces throughout the entire fluid system. Such a design can be critical for minimizing the volume of fluid used to rinse/clean the fluid system. This is important when one is switching between fluids. This becomes of particular importance for a fluid system involving radioactivity, as one wants to minimize the volume of radioactive waste fluids. Further, this is important in order to reduce the amount of lead (or other material) shielding weight needed for the waste fluids. Such a reduction reduces cost and results in greater efficiency.

Further, the quantity of rotary bypass sequences and the order and specific nature of the fluid components can be easily varied.

Each of the patents, patent applications, and articles cited herein is incorporated by reference. The use of the article “a” or “an” is intended to include one or more.

The foregoing description and the examples are intended as illustrative and are not to be taken as limiting. Still, other variations within the spirit and scope of this invention are possible and will readily present themselves to those skilled in the art.

What is claimed is:

1. A fluid flow system comprising:
one or more input fluid containers for inputting fluid into the fluid flow system;
a fluid flow control system coupled to the fluid flow containers, wherein the fluid flow control system controls and regulates fluid flowing through the fluid flow system; and
one or more output fluid containers for receiving fluid outputted from the fluid flow control system.

2. The fluid flow system of claim 1 wherein the fluid flow control system comprises one or more reversing bypass valves.

3. The fluid flow system of claim 1 wherein the fluid flow control system comprises:
a first input selection;
a fluid component;
a reversing bypass valve;
a flow path loop; and
a fluid output selection.

4. The fluid flow system of claim 1 further comprising input fluid components for moving fluid from the input fluid containers to the fluid flow control system, and output fluid components for moving from the fluid flow control system to the output fluid containers.

5. The fluid flow system of claim 1 wherein the system is for chemical elution.

6. The fluid flow system of claim 5 wherein the system is for separation of radionuclides.

7. An elution system, comprising:
a plurality of fluid containers;
a plurality of fluid input components downstream and in fluid communication with the plurality of fluid containers;
at least one fluid input selection downstream and in fluid communication with the plurality of fluid input components;
a first fluid movement device downstream and in fluid communication with the at least one fluid input selection;
a control valve system downstream of the fluid movement device, designed to control a flow path of a fluid flowing through the elution system;
at least one separation column in fluid communication with the control valve system;
at least one fluid output selection downstream of the control valve system and in fluid communication with the control valve system;
a plurality of fluid output components downstream and in fluid communication with the at least one fluid output selection; and
a plurality of fluid output containers downstream and in fluid communication with the plurality of fluid output components.

8. The elution system of claim 7, wherein the control valve system is a reversing bypass valve.

9. The elution system of claim 8, wherein the reversing bypass valve is a rotary reversing bypass valve.

10. The elution system of claim 8, wherein the control valve system comprises a plurality of valves.

11. The elution system of claim 7, further comprising a flow path loop in fluid communication with the control valve system and the first fluid movement device, and upstream of the at least one fluid output selection.

12. The elution system of claim 11, wherein the flow path loop comprises a second fluid movement device.

13. The elution system of claim 11, wherein the flow path loop comprises at least one of a flow sensor, a pressure sensor, a temperature sensor, a fluid conductivity sensor, and a radiation detector.

14. The elution system of claim 13, wherein a position of the control valve system is based on a value from the at least one of the flow sensor, the pressure sensor, the temperature sensor, the fluid conductivity sensor, and the radiation detector.

15. The elution system of claim 11, wherein the at least one separation column is located within the flow path loop.

16. The elution system of claim 11, wherein when the control valve system is in a first position, the fluid flows from the at least one fluid input selection to the at least one fluid output selection, without traveling through the flow path loop.

17. The elution of system of claim 11, wherein when the control valve system is in a second position, the fluid flows from the at least one fluid input selection, through the flow path loop, and to the at least one fluid output selection.

18. The elution system of claim 11, wherein when the control valve system is in a third position, the fluid flow from the at least one fluid output selection, through the flow path loop, and to the at least one fluid input selection.

19. The elution system of claim 7, wherein the at least one separation column is designed to separate radionuclides.

20. The elution system of claim 7, wherein the at least one separation column is designed for a chemical elution process.
